(19) United States
(12) Patent Application Publication
(10) Pub. No.: US 2005/0046922 A1
(43) Pub. Date: Mar. 3, 2005

(54) Interferometric modulation pixels and manufacturing method thereof

(76) Inventors: Wen-Jian Lin, Hsinchu City (TW); Hsiung-Kuang Tsai, Taipei City (TW)

Correspondence Address: GLENN PATENT GROUP, 3475 EDISON WAY, SUITE L, MENLO PARK, CA, 94025, US

(21) Appl. No.: 10/815,905

(22) Filed: Mar. 31, 2004

(30) Foreign Application Priority Data
Sep. 3, 2003 (TW) 92124388

(51) Int. Cl. G02F 1/1335; G02B 26/00

(52) U.S. Cl. 359/291

(57) ABSTRACT

A hydrophobic layer covers the cavity-side surface of the bottom electrode of the interferometric modulation pixel. Consequently, the hydrophobic layer prohibits the hydrophilic surface of the bottom electrode from the adsorption of water molecules, thereby preventing the top electrode from being pulled toward the bottom electrode when the interferometric modulation pixel is active.

### BACKGROUND OF THE INVENTION

1. Field of Invention

The present invention relates to a planar panel display and a manufacturing method thereof. More particularly, the present invention relates to an interferometric modulation pixel and a manufacturing method thereof.

2. Description of Related Art

Planar displays are extremely popular in the portable and limited-space display market because they are lightweight and small. To date, in addition to liquid crystal display (LCD), organic light-emitting diode (OLED) and plasma display panel (PDP) display panels, a module of the optical interference display has been investigated.

The features of an interferometric modulation pixel of the optical interference display include low electrical power consumption, short response time and bi-stable status. Therefore, the optical interference display can be applied in planar display panels, especially in portable products such as mobile phones, personal digital assistants (PDA), and portable computers.

U.S. Pat. No. 5,835,255 discloses a modulator array for visible light, and an interferometric modulation pixel of the modulator array can be used in a planar display panel. FIG. 1A illustrates a cross-sectional diagram showing an interferometric modulation pixel in the prior art. Every interferometric modulation pixel 100 comprises a bottom electrode 102 and a top electrode 104. The bottom electrode 102 and the top electrode 104 are separated by supports 106, thus forming a cavity 108. The distance between the bottom electrode 102 and the top electrode 104, that is, the depth of cavity 108, is D and is usually less than 1 μm. The bottom electrode 102 is a light-incident electrode and partially absorbs visible light according to absorption rates of various wavelengths. The top electrode 104 is a light-reflection electrode which is flexed toward the bottom electrode 102 when a voltage is applied to it.

A white light is usually used as an incident light source for the interferometric modulation pixel 100 and represents a mixture of various wavelengths (represented by λ) of light in the visible light spectrum. When the incident light shines through the bottom electrode 102 and enters the cavity 108, only the visible light with wavelength (λ₁) corresponding to the formula 1.1 is reflected back, that is,
2D=Nλ₁ (1.1),
wherein N is a natural number.

When twice the cavity depth, 2D, equals one certain wavelength λ₁ of the incident light multiplied by any natural number, N, a constructive interference is produced, and a light with the wavelength λ₁ is reflected back. Thus, an observer viewing the panel from the direction of the incident light will observe light with the certain wavelength λ₁ reflected back at him. The display unit 100 here is in an “open” state, i.e. a “bright” state.

FIG. 1B illustrates a cross-sectional diagram of the interferometric modulation pixel 100 in FIG. 1A after a voltage is applied to it. Under the applied voltage, the top electrode 104 is flexed by electrostatic attraction toward the bottom electrode 102. At this moment, the distance between the walls 102 and 104, the depth of cavity 108, becomes d and may equal zero. The D in the formula 1.1 is hence replaced with d, and only the visible light with another certain wavelength λ₂ satisfying the formula 1.1 produces constructive interference and reflects through the top electrode 102. However, in the interferometric modulation pixel 100, the bottom electrode 102 is designed to have a high absorption rate for the light with the wavelength λ₂. Thus, the incident visible light with the wavelength λ₂ is absorbed, and the light with other wavelengths is annulled by destructive interference. The incident visible light of all wavelengths is thereby filtered, and the observer is unable to see any reflected visible light when the top electrode 104 is flexed. The interferometric modulation pixel 100 is now in a “closed” state, i.e. a “dark” state.

As described above, under the applied voltage, the top electrode 104 is flexed by electrostatic attraction toward the bottom electrode 102 such that the interferometric modulation pixel 100 is switched from the “open” state to the “closed” state. When the interferometric modulation pixel 100 is switched from the “closed” state to the “open” state, the voltage for flexing the top electrode 104 is removed, and the top electrode 104 elastically returns to the original state, i.e. the “open” state as illustrated in FIG. 1A.

In light of foregoing, the interferometric modulation pixel 100 is obtained by combining thin film interference principles of optics with the reflective plate and microelectromechanical system (MEMS) processes. In a MEMS process, the cavity 108 is formed by etching a sacrificial layer between the bottom electrode 102 and the top electrode 104. After removing the sacrificial layer, water vapor can be easily adsorbed within the cavity 108, creating an undesired electrostatic attractive force between the bottom electrode 102 and the top electrode 104. The electrostatic attractive force created by the water molecules can switch the “open” state of the display unit to its “closed” state. Hence, a display unit using interferometric modulation and a manufacturing method thereof are needed to avoid the adsorption of water molecules within the cavity 108 and thereby eliminate the possibility of forming an undesired electrostatic attractive force.

### SUMMARY OF THE INVENTION

In one aspect, the present invention provides an interferometric modulation pixel and a manufacturing method of which a hydrophobic layer is formed on the bottom electrode to protect the upper surface of the bottom electrode from adsorbing water molecules.

In another aspect, the present invention provides an interferometric modulation pixel and a manufacturing method of which a hydrophobic layer is formed on the bottom electrode to maintain the distance between the bottom electrode and the top electrode such that the top electrode is not pulled toward the bottom electrode due to adsorbed moisture in the cavity.

In yet another aspect, the present invention provides an interferometric modulation pixel and a manufacturing method that enhances the image display quality of the planar optical interference display.

In accordance with the foregoing and other aspects of the present invention, the present invention provides a method of manufacturing an interferometric modulation pixel. A first electrode layer and a sacrificial layer are sequentially formed on a transparent substrate, wherein an uppermost layer of the first electrode layer is an insulating layer. At least two first openings are formed in the sacrificial layer and the first electrode layer to demarcate and define a first electrode. A photosensitive material is formed on the sacrificial layer and within the first openings and is then partially removed to leave supports in the first openings. A second electrode layer is formed on the sacrificial layer and the supports. Then, at least two second openings are formed in the second electrode layer to demarcate and define a second electrode such that the two second openings perpendicularly crisscross the two first openings. The sacrificial layer is then removed, and a hydrophobic layer is formed on the insulating layer.

In the foregoing, the hydrophobic layer is formed by adsorbing a layer of a hydrophobic organic compound having at least a hydrogen atom being capable of forming hydrogen bonds with oxygen or nitrogen atoms. The hydrophobic organic compound comprises silanes including hexamethyl disilane or silanols including trimethyl silanol.

In accordance with the foregoing and other aspects of the present invention, the present invention provides another method of manufacturing an interferometric modulation pixel. A first electrode layer, a hydrophobic layer and a sacrificial layer are sequentially formed on a transparent substrate, wherein an uppermost layer of the first electrode layer is an insulating layer. At least two first openings are formed in the sacrificial layer, the hydrophobic layer and the first electrode layer to demarcate and define a first electrode. A photosensitive material is formed on the sacrificial layer and in the first openings and is then partially removed to leave supports in the first openings. A second electrode layer is formed on the sacrificial layer and the supports. Then, at least two second openings are formed in the second electrode layer to demarcate and define a second electrode such that the two second openings perpendicularly crisscross the two first openings. The sacrificial layer is then removed.

In the foregoing, the hydrophobic layer may comprise a hydrophobic resin.

In accordance with the foregoing and other aspects of the present invention, the present invention provides an interferometric modulation pixel. The interferometric modulation pixel comprises a first electrode, a movable second electrode situated above the first electrode, two supports between the first electrode and the second electrode for forming a cavity between the first and second electrodes, and a hydrophobic layer on the cavity-side surface of the bottom electrode. Materials for use as the hydrophobic layer include a hydrophobic resin and a hydrophobic organic compound having at least a hydrogen atom being capable of forming hydrogen bonds with oxygen or nitrogen atoms. The hydrophobic organic compound comprises silanes including hexamethyl disilane or silanols including trimethyl silanol.

In light of the preferred embodiments of the present invention described above, a hydrophobic layer covers the insulating layer of the bottom electrode to prevent adsorption of water molecules. Hence, the distance between the bottom electrode and the top electrode is not decreased due to the adsorption of water molecules and thereby provides a high-quality image display.

It is to be understood that both the foregoing general description and the following detailed description are made by use of examples and are intended to provide further explanation of the invention as claimed.

### BRIEF DESCRIPTION OF THE DRAWINGS

The accompanying drawings are included to provide a better understanding of the invention and are incorporated in and constitute a part of this specification. The drawings illustrate embodiments of the invention and, together with the description, serve to explain the principles of the invention. In the drawings,

FIG. 1A illustrates a cross-sectional diagram showing an interferometric modulation pixel in the prior art;

FIG. 1B illustrates a cross-sectional diagram of the interferometric modulation pixel 100 in FIG. 1A after a voltage is applied to it;

FIGS. 2A-2D are cross-sectional diagrams showing a process of manufacturing an interferometric modulation pixel according to a preferred embodiment of this invention; and

FIGS. 3A-3D are cross-sectional diagrams showing a process of manufacturing an interferometric modulation pixel according to another preferred embodiment of this invention.

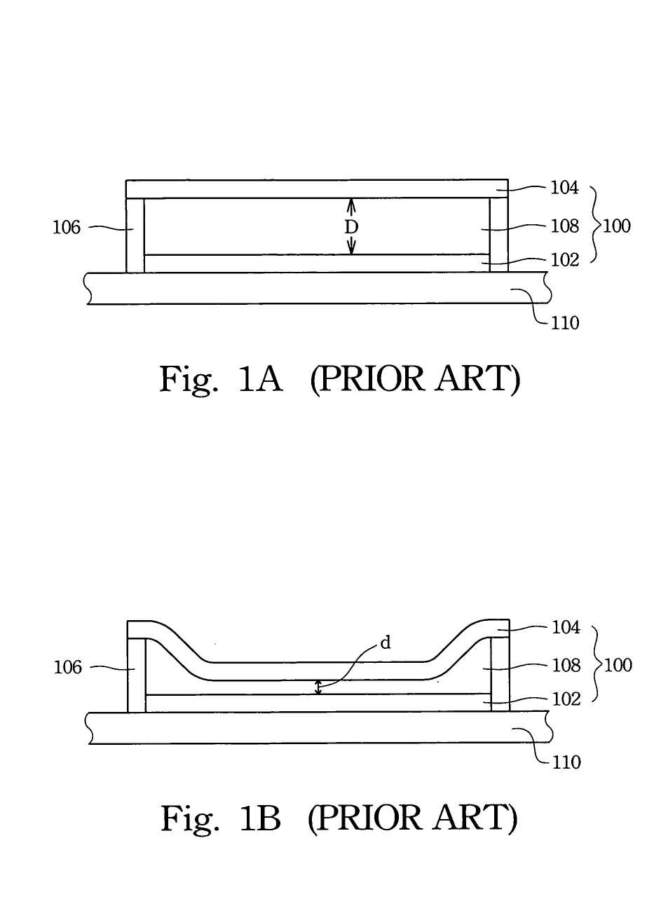

### DESCRIPTION OF THE PREFERRED EMBODIMENTS

The bottom electrode of the prior art interferometric modulation pixel is made of a transparent conductive layer, a light-absorption layer and a silicon-based insulation layer. The silicon-based insulation layer is usually a silicon oxide layer or a silicon nitride layer, both of which are hydrophilic. The cavity depth of the interferometric modulation display unit is the distance between the bottom electrode and the top electrode after a sacrificial layer therebetween is etched away by a structural release etching process. The cavity depth is usually on the order of one micrometer or even smaller. Therefore, water vapor in the air is very easily adsorbed within the cavity to create an undesired electrostatic attractive force between the bottom and the top electrodes that permanently forces the interferometric modulation pixel to appear as the “closed” state and consequently produces image defects.

Therefore, this invention provides an interferometric modulation pixel and a manufacturing method thereof to solve the prior art problem of the adsorption of water molecules onto the bottom electrode. In a preferred embodiment of the present invention, the bottom electrode is covered by a hydrophobic layer in order to prohibit the bottom electrode from adsorbing water molecules.

Reference will now be made in detail to the present preferred embodiments of the invention, examples of which are illustrated in the accompanying drawings.

Embodiment 1

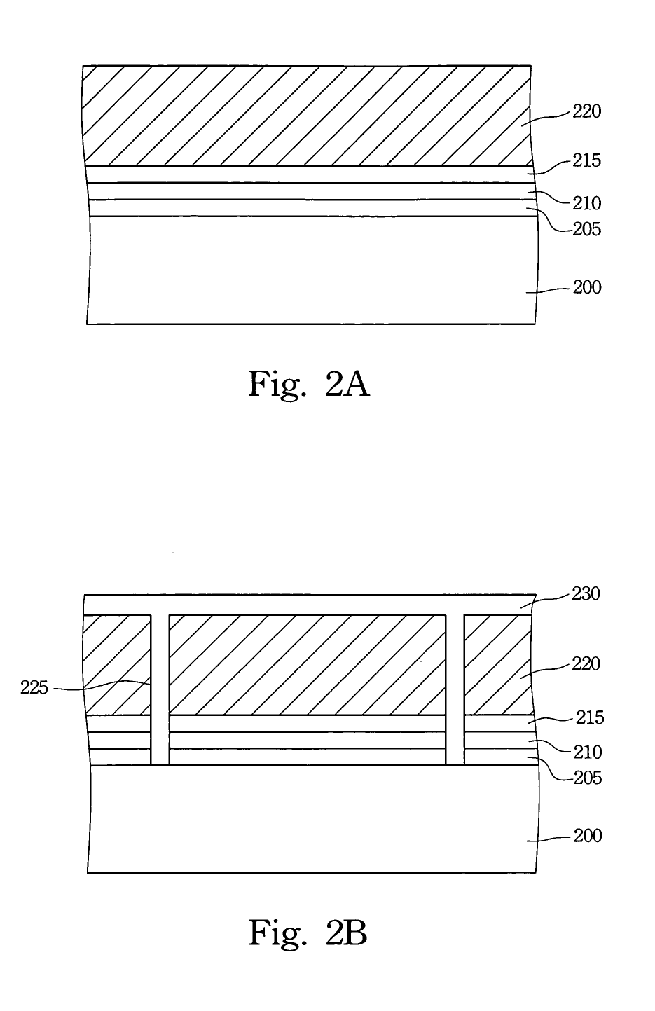

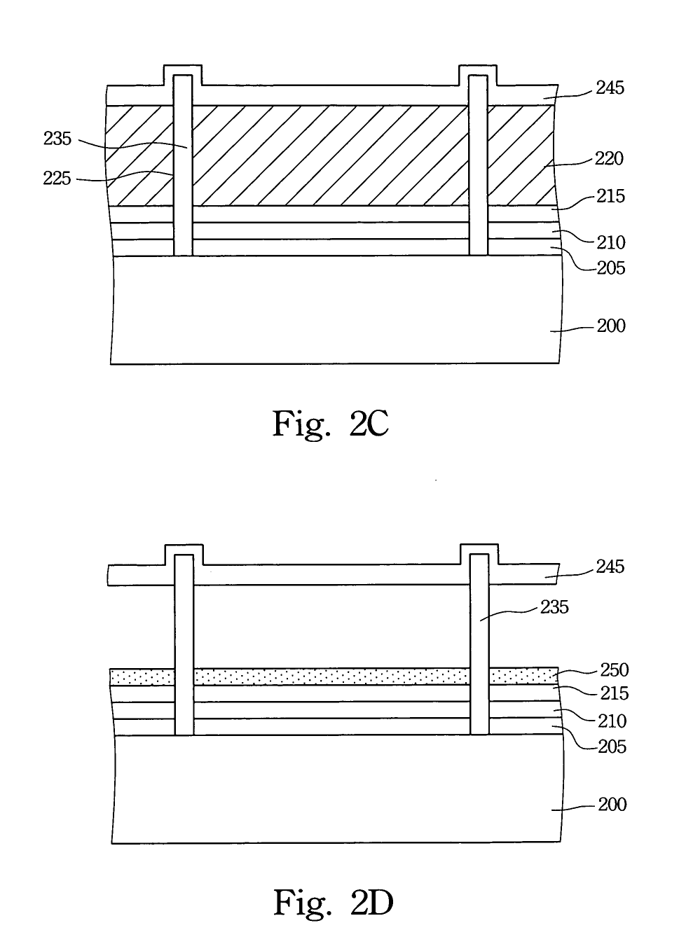

FIGS. 2A-2D are cross-sectional diagrams showing a process of manufacturing an interferometric modulation pixel according to a preferred embodiment of this invention. In FIG. 2A, a transparent conductive layer 205, a light-absorption layer 210, an insulating layer 215, and a sacrificial layer 220 are sequentially formed on a transparent substrate 200.

The transparent conductive layer 205 is preferably made of indium tin oxide (ITO), indium zinc oxide (IZO), zinc oxide or indium oxide. The light-absorption layer 210 is preferably made of aluminum, silver or chromium. The insulating layer 215 may be comprised of silicon oxide or silicon nitride. The sacrificial layer 220 is made of metal, amorphous silicon, polysilicon or other suitable material.

In FIG. 2B, at least two first openings 225 are formed in the sacrificial layer 220, the insulating layer 215, the light-absorption layer 210 and the transparent conductive layer 205 by a process such as photolithography and etching to define a bottom electrode. The first openings 225 are substantially oriented perpendicularly to the diagram surface such that the openings can be likened to channels, and only the cross-sections of the channels are visible in the diagram. The bottom electrode of the interferometric modulation pixel is located between the two first openings 225 and is formed by stacking the transparent conductive layer 205, the light-absorption layer 210, and the insulating layer 215.

Then, a photosensitive material 230 is coated on the sacrificial layer 220 and inside of the first openings 225. The photosensitive material 230 comprises positive photoresist, negative photoresist, or various kinds of photosensitive polymers such as polyimide, acrylic resins, or epoxy resins.

In FIG. 2C, supports 235 in the first openings 225 are formed by exposing and developing the photosensitive material 230. A reflective conductive layer 245 is formed on the sacrificial layer 220 and the supports 235. Then, at least two second openings (not shown in FIG. 2C) are formed in the reflective conductive layer 245 by a process such as photolithography and etching to demarcate and define a top electrode between the two second openings. The orientation of the second openings is parallel to the diagram surface. The top electrode is formed from the reflective conductive layer 245 and is a light-reflection electrode. The top electrode can be flexed to move up and down. The material used as the reflective conductive layer 245 must be reflective so as to reflect the incident light from the bottom electrode. The reflective conductive layer 245 preferably comprises metal.

In FIG. 2D, the sacrificial layer 220 is removed by a structural release etching process such as remote plasma etching. The precursor of the remote plasma includes a fluorine-based or chlorine-based etchant, such as xenon difluoride, carbon tetrafluoride, boron trichloride, nitrogen trifluoride, sulfur hexafluoride, or combinations thereof.

In a moisture-free environment or in a vacuum, a hydrophobic layer 250 is formed on the surface of the insulating layer 215. The method used for forming the hydrophobic layer 250 includes introducing a gas of a hydrophobic organic compound into a reaction chamber such that the gas condenses and adsorbs onto the insulating layer 215. The hydrophobic organic compound must have at least a hydrogen atom that can form a hydrogen bond with the lone pair electrons of oxygen or nitrogen atoms on the surface of the insulating layer 215. Consequently, the oxygen or nitrogen atoms in the insulating layer 215 are unable to form hydrogen bonds with water molecules, preventing adsorption of water molecules. The hydrophobic organic compound includes silanes, such as hexamethyl disilanes, or silanols, such as trimethyl silanol.

Embodiment 2

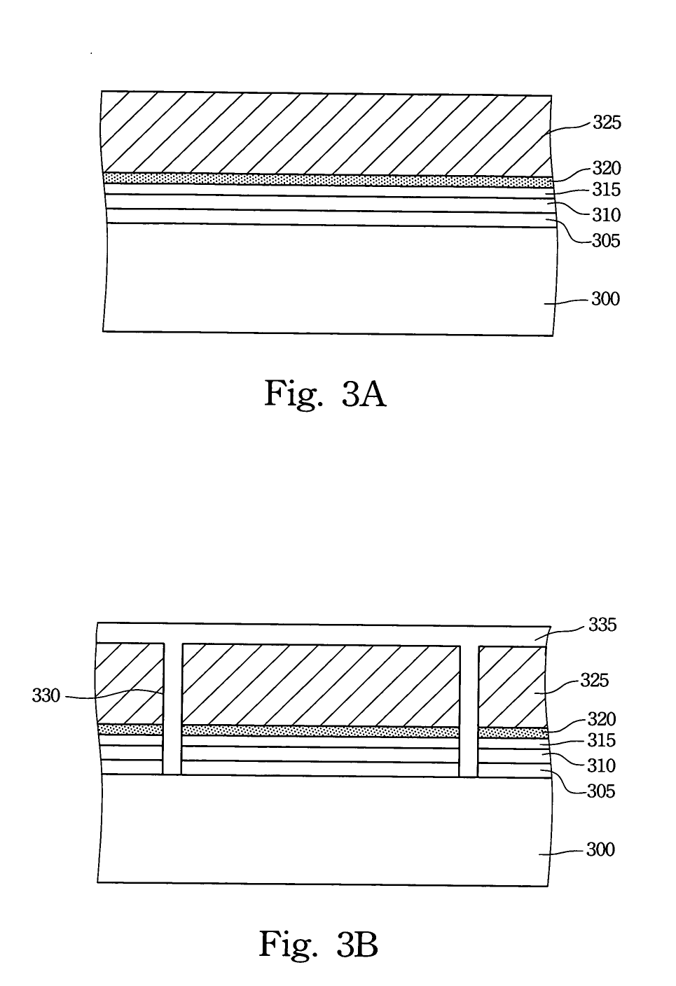

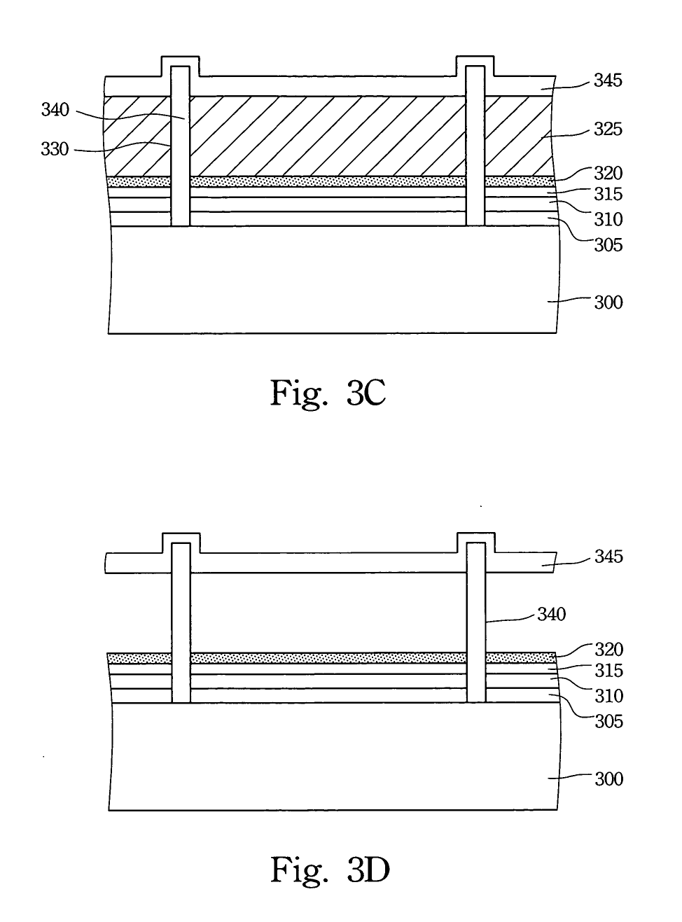

FIGS. 3A-3D are cross-sectional diagrams showing a process of manufacturing an interferometric modulation pixel according to another preferred embodiment of this invention. In FIG. 3A, a transparent conductive layer 305, a light-absorption layer 310, an insulating layer 315, a hydrophobic layer 320 and a sacrificial layer 325 are sequentially formed on a transparent substrate 300.

The transparent conductive layer 305 is preferably comprised of indium tin oxide (ITO), indium zinc oxide (IZO), zinc oxide or indium oxide. The light-absorption layer 310 is made of a metal such as aluminum, silver or chromium. The insulating layer 315 is preferably comprised of silicon oxide or silicon nitride. In this embodiment, the hydrophobic layer 320 is made of a hydrophobic resin. The sacrificial layer 325 preferably comprises metal, amorphous silicon or polysilicon.

In FIG. 3B, at least two first openings 330 are formed in the sacrificial layer 325, the hydrophobic layer 320, the insulating layer 315, the light-absorption layer 310 and the transparent conductive layer 305 by a process such as photolithography and etching to demarcate and define a bottom electrode. The first openings 330 are substantially oriented perpendicularly to the diagram surface such that the openings can be likened to channels, and only the cross-sections of the channels are visible in the diagram. The bottom electrode of the interferometric modulation pixel is located between the two first openings 330 and is formed by stacking the transparent conductive layer 305, the light-absorption layer 310, and the insulating layer 315. Then, a photosensitive material 335 is coated on the sacrificial layer 325 and inside the first openings 330. The photosensitive material 335 comprises positive photoresist, negative photoresist, or various kinds of photosensitive polymers such as polyimide, acrylic resins, or epoxy resins.

In FIG. 3C, supports 340 in the first openings 330 are formed by exposing and developing the photosensitive material 335. A reflective conductive layer 345 is formed on the sacrificial layer 325 and the supports 340. Then, at least two second openings (not shown in FIG. 2C) are formed in the reflective conductive layer 345 by a process such as photolithography and etching to define a top electrode between the two second openings. The orientation of the second openings is parallel to the diagram surface. The top electrode is formed from the reflective conductive layer 345 and is a light-reflection electrode. The top electrode can be flexed to move up and down. The material used as the reflective conductive layer 345 must be reflective so as to reflect the incident light from the bottom electrode. The material of the reflective conductive layer 345 preferably comprises metal.

In FIG. 3D, the sacrificial layer 325 is removed by a structural release etching process, such as remote plasma etching. The precursor of the remote plasma includes a fluorine-based or chlorine-based etchant, such as xenon difluoride, carbon tetrafluoride, boron trichloride, nitrogen trifluoride, sulfur hexafluoride, or combinations thereof.

In light of the preferred embodiments of the present invention described above, a hydrophobic layer covers the insulating layer of the bottom electrode to prohibit adsorption of water molecules. Hence, the distance between the bottom electrode and the top electrode is not decreased by the adsorption of water molecules and thereby provides a high-quality image display.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method of manufacturing an interferometric modulation pixel, comprising:
forming a first electrode layer on a transparent substrate, wherein an uppermost layer of the first electrode layer is an insulating layer;
forming a sacrificial layer on the insulating layer;
forming at least two first openings in the sacrificial layer and the first electrode layer to demarcate and define a first electrode, wherein the first electrode is made from the first electrode layer;
coating a photosensitive material on the sacrificial layer and in the first openings;
patterning the photosensitive material to form supports in the first openings;
forming a second electrode layer on the sacrificial layer and the supports;
forming at least two second openings in the second electrode layer to define a second electrode, wherein the second electrode is made from the second electrode layer and the orientation of the two second openings is perpendicular to the two first openings;
removing the sacrificial layer; and
forming a hydrophobic layer on the insulating layer.

2. The method of claim 1, wherein the insulating layer comprises silicon oxide or silicon nitride.

3. The method of claim 1, wherein the sacrificial layer comprises metal, polysilicon or amorphous silicon.

4. The method of claim 1, wherein a method of forming the first openings and the second openings comprises photolithography and etching.

5. The method of claim 1, wherein the photosensitive material comprises photoresists or photosensitive polymer.

6. The method of claim 1, wherein a method of patterning the photosensitive material comprises exposing and developing the photosensitive material.

7. The method of claim 1, wherein the sacrificial layer is removed by remote plasma etching.

8. The method of claim 7, wherein a plasma precursor used by the remote plasma etching comprises a fluorine-based or chlorine-based etchant.

9. The method of claim 1, wherein the hydrophobic layer is formed by adsorbing a layer of a hydrophobic organic compound having at least a hydrogen atom being capable of forming hydrogen bonds with oxygen or nitrogen atoms.

10. The method of claim 9, wherein the hydrophobic organic compound comprises silanes including hexamethyl disilane or silanols including trimethyl silanol.

11. A method of manufacturing an interferometric modulation pixel, comprising:
forming a first electrode layer on a transparent substrate, wherein a uppermost layer of the first electrode layer is an insulating layer;
forming a hydrophobic layer on the insulating layer
forming a sacrificial layer on the hydrophobic layer;
forming at least two first openings in the sacrificial layer, the hydrophobic layer and the first electrode layer to define a first electrode, wherein the first electrode is made from the first electrode layer;
coating a photosensitive material on the sacrificial layer and in the first openings;
patterning the photosensitive material to form supports in the first openings;
forming a second electrode layer on the sacrificial layer and the supports;
forming at least two second openings in the second electrode layer to define a second electrode, wherein the second electrode is made from the second electrode layer and the orientation of the two second openings is perpendicular to the two first openings; and
removing the sacrificial layer.

12. The method of claim 11, wherein the insulating layer comprises silicon oxide or silicon nitride.

13. The method of claim 11, wherein the hydrophobic layer comprises hydrophobic resin.

14. The method of claim 11, wherein the sacrificial layer comprises metal, polysilicon or amorphous silicon.

15. The method of claim 11, wherein a method of forming the first openings and the second openings comprises photolithography and etching.

16. The method of claim 11, wherein the photosensitive material comprises photoresists or photosensitive polymer.

17. The method of claim 11, wherein a method of patterning the photosensitive material comprises exposing and developing the photosensitive material.

18. The method of claim 11, wherein the sacrificial layer is removed by remote plasma etching.

19. The method of claim 18, wherein a plasma precursor used by the remote plasma etching comprises a fluorine-based or chlorine-based etchant.

20. An interferometric modulation pixel, comprising:
a first electrode;
a movable second electrode being situated above the first electrode and being parallel to the first electrode;
two supports between the first electrode and the second electrode to form a cavity within the first and the second electrodes; and
a hydrophobic layer on a cavity-side surface of the first electrode to prevent the first electrode from adsorbing water molecules.

21. The interferometric modulation pixel of claim 20, wherein the hydrophobic layer comprises a hydrophobic organic compound having at least a hydrogen atom being capable of forming hydrogen bonds with oxygen or nitrogen atoms or a hydrophobic resin.

22. The interferometric modulation pixel of claim 20, wherein the hydrophobic organic compound comprises silanes including hexamethyl disilane or silanols including trimethyl silanol.
